(19) United States
(12) Patent Application Publication
(10) Pub. No.: US 2016/0325234 A1
(43) Pub. Date: Nov. 10, 2016

(54) FORWARD OSMOSIS WATER TREATMENT DEVICE

(71) Applicant: SAMSUNG ELECTRONICS CO., LTD, Suwon-si (KR)

(72) Inventors: Bok Soon KWON, Suwon-si (KR); Hyoung Woo CHOI, Hwaseong-si (KR); Chang Won SUH, Incheon (KR); Sung Soo HAN, Hwaseong-si (KR)

(73) Assignee: Samsung Electronics Co., Ltd, Suwon-si (KR)

(21) Appl. No.: 15/111,624

(22) PCT Filed: Jan. 14, 2015
(86) PCT No.: PCT/KR2015/000393

§ 371 Date: Jul. 14, 2016

(30) Foreign Application Priority Data
Jan. 17, 2014 (KR) 10-2014-0006309

(51) Int. Cl. B01D 63/08; B01D 71/56; C02F 1/44; B01D 71/68; B01D 61/00; B01D 69/12

(52) U.S. Cl. CPC B01D 63/084; B01D 61/002; B01D 69/12; C02F 1/445; B01D 71/68; B01D 71/56; B01D 2313/04; B01D 2313/143; B01D 2313/146; B01D 2315/10; B01D 2317/02

(57) ABSTRACT

A forward osmosis water treatment device includes a plurality of forward osmosis separation membrane in which each forward osmosis separation membrane includes an active layer and a support layer, first spacers disposed between two active layers facing each other, and second spacers disposed between two support layers facing each other, wherein a plurality of the first spacers and the second spacers are included so as to form a stack structure together with the forward osmosis membranes, the plurality of the first spacers form a first flow path forming a flow of water to be treated, and the plurality of the second spacers form a second flow path forming a flow of a draw solution.

### CROSS REFERENCE TO RELATED APPLICATIONS

This is a National Phase Application of PCT/KR2015/000393, filed Jan. 14, 2015, which is an International Application designating the United States of America, and claiming priority to Korean Patent Application No. 10-2014-0006309, filed in the Korean Intellectual Property Office on Jan. 17, 2014, the entire contents of each of which are hereby incorporated herein by reference.

### FIELD

A forward osmosis water treatment device is disclosed.

### BACKGROUND

A forward osmosis process uses a natural phenomenon (osmosis) of transporting a solvent of solution having a low concentration into a solution having a high concentration to reach an equilibrium concentration by providing a semi-permeable membrane between the solution having a high concentration and the solution having a low concentration. The forward osmosis (FO) may save the energy cost since a draw solution having a high osmotic pressure makes a driving pressure, unlike a reverse osmosis (RO) using a pressure generated by a high-pressure pump as a driving pressure.

In order to accomplish a separation membrane module using the forward osmosis, it is important to reduce a concentration polarization (CP) phenomenon which may be occurred in the separation membrane, and it is also important to reduce a fluid resistance generation and a pressure which may be generated in the module. For this purpose, it is important to appropriately design a flow path of forward osmosis water treatment device.

### SUMMARY

Provided is a forward osmosis water treatment device being capable of simultaneously satisfying both the water permeability characteristics and the back diffusion characteristics of salts, which are required for a separation membrane.

According to an embodiment, a forward osmosis water treatment device includes a plurality of forward osmosis separation membranes in which each forward osmosis separation membrane includes an active layer and a support layer, first spacers disposed between two active layers facing each other, and second spacers disposed between two support layers facing each other, wherein a plurality of the first spacers and the second spacers are included so as to form a stack structure together with the forward osmosis membranes, the plurality of the first spacers form a first flow path forming a flow of water to be treated, and the plurality of the second spacers form a second flow path forming a flow of a draw solution.

The forward osmosis separation membrane may selectively permeate water, so as to transport water of the water to be treated passing through the first spacers into the draw solution passing through the second spacers.

The first flow path and the second flow path may be formed by each penetrating at least one of the plurality of forward osmosis separation membranes.

The first spacers may include a region where the water to be treated may be transported along with a transverse direction of the first spacers; and the second spacers may include a region where the draw solution may be transported along with a transverse direction of the second spacers.

The first spacers and the second spacers may include mesh region, respectively.

The first spacers and the second spacers may include a gasket defining the mesh region, respectively.

The gasket may have an inlet capable of passing each of the water to be treated and the draw solution.

The inlet may be disposed at the end of the gasket or disposed by penetrating the gasket.

The direction of transporting the water to be treated along with the transverse direction of the first spacers may be same as the direction of transporting the draw solution along with a transverse direction of the second spacers.

The direction of transporting the water to be treated along with the transverse direction of the first spacers may be different from the direction of transporting the draw solution along with a transverse direction of the second spacers.

The forward osmosis water treatment device may further include a first supplier configured to feed water to be treated; a second supplier configured to feed a draw solution; a first outlet discharging the water to be treated fed from the first supplier and passed through a plurality of first spacers; and a second outlet discharging the draw solution fed from the second supplier and passed through the plurality of second spacers, wherein the first supplier, the plurality of first spacers and the first outlet form a first flow path providing a flow of the water to be treated, and the second supplier, the plurality of second spacers and the second outlet form a second flow path providing a flow of the draw solution.

The water to be treated passing through the first flow path may be fluidically separated from the draw solution passing through the second flow path.

The first flow path may have a structure extended from the first supplier and branching each the first spacers; the second flow path may have a structure extended from the second supplier and branching each the second spacers.

The first flow path may have a structure extended from the first supplier sequentially passing the first spacers; the second flow path may have a structure extended from the second supplier and sequentially passing the second spacers.

The water to be treated discharged from the first outlet may have a higher concentration than the water to be treated fed from the first supplier.

The forward osmosis separation membrane may be a plate-and-frame type.

The forward osmosis separation membrane may be more easily designed and also simultaneously satisfy water permeability characteristics required for the separation membrane and back diffusion characteristics of salts.

### BRIEF DESCRIPTION OF DRAWINGS

FIG. 1 is a schematic view of a forward osmosis water treatment device according to an embodiment,

FIGS. 2 to 5 are schematic views of each forward osmosis water treatment device according to embodiments,

FIGS. 6 and 7 are each schematic views showing examples of flow path applied to a forward osmosis water treatment device according to an embodiment,

FIG. 8 is a graph of showing a water permeability of forward osmosis water treatment devices according to Examples 1 to 3 compared to a forward osmosis water treatment device according to Comparative Example 1,

FIG. 9 is a graph of showing a water permeability of forward osmosis water treatment devices according to Examples 4 to 6 compared to a forward osmosis water treatment device according to Comparative Example 1,

FIGS. 10 and 11 are graphs showing a water permeability considering an membrane area of forward osmosis water treatment devices according to Examples 1 to 3 compared to a forward osmosis water treatment device according to Comparative Example 1,

FIGS. 12 and 13 are graphs showing a water permeability considering an membrane area of forward osmosis water treatment devices according to Examples 4 to 6 compared to a forward osmosis water treatment device according to Comparative Example 1,

FIG. 14 is a graph showing back diffusion characteristics of salts of forward osmosis water treatment devices according to Examples 3 and 6, and Comparative Example 1,

FIG. 15 is a graph showing pressures generated in a flow path of a forward osmosis water treatment device according to Comparative Example 1,

FIG. 16 is a graph showing pressures generated in a flow path of a forward osmosis water treatment device according to Example 3, and

FIG. 17 is a graph showing pressures generated in a flow path of a forward osmosis water treatment device according to Example 6.

### DETAILED DESCRIPTION

Exemplary embodiments of the present invention will hereinafter be described in detail, and may be easily performed by those who have common knowledge in the related art. However, this disclosure may be embodied in many different forms and is not construed as limited to the example embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In the drawings, parts having no relationship with the description are omitted for clarity of the embodiments, and the same or similar constituent elements are indicated by the same reference numerals throughout the specification.

Hereinafter, ‘a combination thereof’ refers to a mixture and a stacking structure of two or more.

A forward osmosis water treatment device is operated by transporting water to be treated, that is a subject to be treated to a draw solution having a high concentration using osmotic pressure through a forward osmosis separation membrane, transporting the draw solution to a recovery system to separate a solute, and obtaining the remainder as treated outlet water.

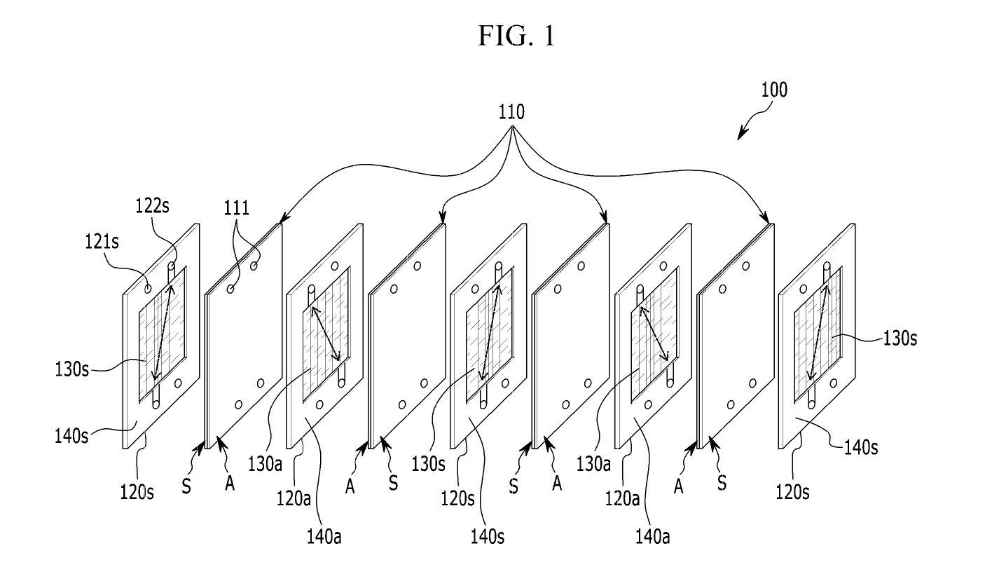

Hereinafter, a forward osmosis water treatment device according to an embodiment is described with reference to FIG. 1.

FIG. 1 is a schematic view of a forward osmosis water treatment device according to an embodiment.

Referring to FIG. 1, a forward osmosis water treatment device 100 according to an embodiment includes a plurality of forward osmosis separation membrane 110 in which each forward osmosis separation membrane 110 includes an active layer (A) and a support layer (S), first spacers 120a disposed between two active layers (A) facing each other, and second spacers 120s disposed between two support layers (S).

The active layer (A) separates salts from water to be treated, and may include, for example polyamide, cross-linked polyamide, polyamide-hydrazide, poly(amide-imide), polyimide, poly(allylamine)hydrochloride/poly(sodiumstyrenesulfonate) (PAH/PSS), polybenzimidazole, sulfonated poly(aryleneethersulfone), or a combination thereof.

The support layer (S) supports an active layer from water pressure, and may include, for example a polysulfone-based polymer selected from polysulfone, polyethersulfone and poly(ethersulfoneketone); a poly(meth)acrylonitrile polymer selected from polyacrylonitrile and polymethacrylonitrile; a polyolefin-based polymer selected from polyethylene, polypropylene and polystyrene; polycarbonate; polyalkyleneterephthalate selected from polyethylene terephthalate, and polybutylene terephthalate; a polyimide-based polymer; a polybenzimidazole-based polymer; a polybenzthiazole-based polymer; a polybenzoxazole-based polymer; a polyepoxy-based polymer; a polyphenylenevinylene-based polymer; a polyamide-based polymer; a cellulose-based polymer; polyvinylidene fluoride (PVDF); polytetrafluoroethylene (PTFE); polyvinylchloride (PVC), or a combination thereof.

For example, one forward osmosis separation membrane 110 may have a thickness of, for example, about 30 μm to about 200 μm, for example, about 50 μm to about 150 μm, but is not limited thereto.

The first spacers 120a and the second spacers 120s are included in plural, so as to form a stack structure together with a forward osmosis separation membrane 110. The stack structure shown in FIG. 1 is only example, but it may further include an additional forward osmosis separation membrane and/or spacers in the outer side, and the number of forward osmosis separation membrane and the spacers included in the stack structure is not limited. This is same in another embodiment and examples which will be described later.

The forward osmosis separation membrane 110 may selectively permeate water, so as to transfer water of water to be treated passing through the first spacers 120a to the draw solution passing through the second spacers 120s.

The first spacers 120a may include a region where the water to be treated may be transported along with the transverse direction of the first spacers 120a; the second spacers 120s may include a region where the draw solution may be transported along with the transverse direction of the second spacers 120s.

For example, the first spacers 120a and the second spacers 120s may include the mesh regions 130a and 130s, respectively. The water to be treated may be transported along with the transverse direction of the first spacers 120a through the mesh region 130a; and the draw solution may be transported along with the transverse direction of the second spacers 120s through the mesh region 130s. In FIG. 1, the arrows indicated in the mesh regions 130a and 130s exemplarily show flows transporting the water to be treated and the draw solution from one direction to the other direction. The mesh 130a of the first spacers 120a and the mesh 130s of the second spacers 120s may be hydrodynamically symmetric or asymmetric to each other.

The shapes and the sizes of the meshes 130a and 130s are not limited as long as forming a fluidal flow. For example, the unit hole of the meshes 130a and 130s may be a circle, a triangle, a quadrangle, or a pentangle shape and may have an average diameter of about 1 mm to about 10 mm. The meshes 130a and 130s may be made of polyester, polypropylene or a combination thereof, but is not limited thereto.

The thickness of the first spacers 120a may be same as or different from the thickness of the second spacers 120s. For example, the thickness of the first spacers 120a may be about 0.3 mm to 1.0 mm, and the thickness of the second spacers 120s may be about 0.5 mm to 1.5 mm, but are not limited thereto.

It may each include gaskets 140a and 140s defining the mesh regions 130a and 130s, respectively. The gaskets 140a and 140s may be made of any material without limitation as long as not causing a leakage. For example, the material may be a rubber material such as a natural rubber, a styrene butadiene rubber, a nitrile butadiene rubber, a chloroper rubber, or a fluorine rubber. Besides, it may exemplarily include silicone or, for example, PTFE (poly tetrafluoro ethylene) such as TEFLON (tetrafluoroethylene), but is not limited thereto.

The gaskets 140a and 140s may have inlets 121a, 122a, 121s, and 122s being capable of passing the water to be treated and the draw solution, respectively. In addition, the forward osmosis separation membrane 110 may have through-holes 111 for transferring the water to be treated and the draw solution into the adjacent inlets 121a, 122a, 121s, and 122s. The inlets 121a, 122a, 121s, and 122s and the through-hole 111 shown in FIG. 1 are exemplarily illustrated, but the numbers and the positions thereof are not limited thereto.

The first spacers 120a and the second spacers 120s are included in a plurality to form a stack structure together with the forward osmosis separation membrane 110, wherein the plurality of the first spacers 120a provides a first flow path forming a flow of the water to be treated, and the plurality of the second spacers 120s provides a second flow path forming a flow of the draw solution.

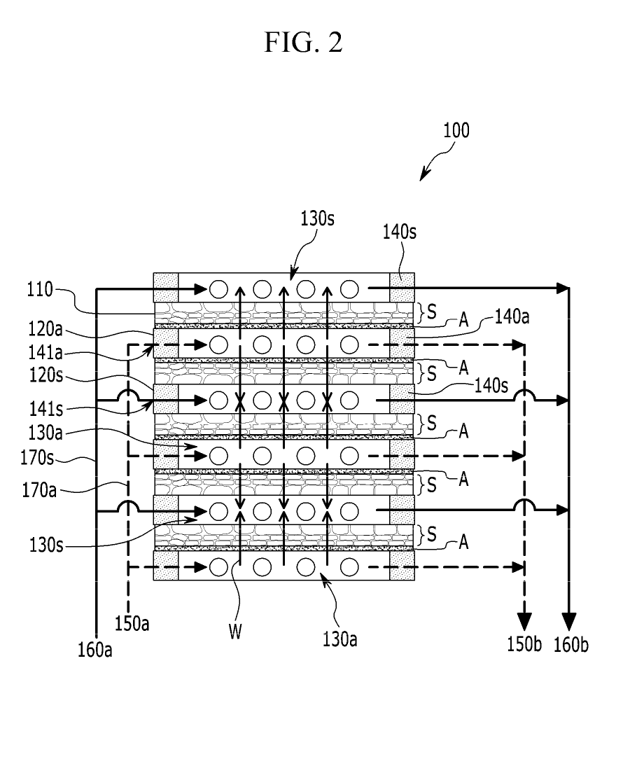

The first flow path and the second flow path are specifically described with reference to FIGS. 2 to 5.

FIGS. 2 to 5 are schematic cross-sectional views of forward osmosis water treatment devices according to Examples.

Referring to FIGS. 2 to 5, the forward osmosis water treatment devices 100 further include a first supplier 150a configured to feed water to be treated, a second supplier 160a configured to feed a draw solution, a first outlet 150b discharging water to be treated fed from the first supplier 150a and passed through a plurality of first spacers 120a and a second outlet 160b discharging the draw solution fed from the second supplier 160a and passed through a plurality of the second spacers 120s. The first supplier 150a, the plurality of the first spacers 120a, and the first outlet 150b form a first flow path 170a for forming a flow of water to be treated; and the second supplier 160a, the plurality of the second spacers 120s and the second outlet 160b form a second flow path 170s forming a flow of draw solution. The water to be treated passing the first flow path 170a and the draw solution passing the second flow path 170b are fluidically separated, so as to form each flow.

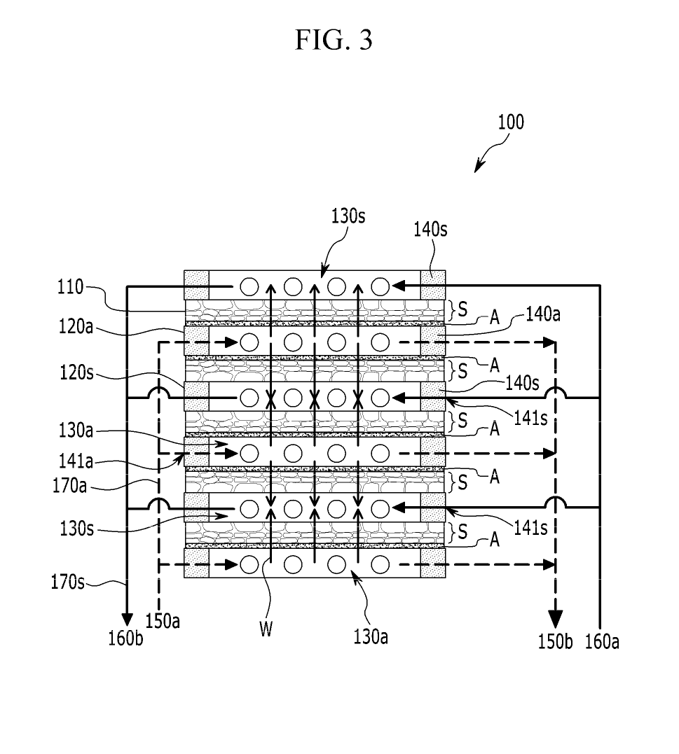

Referring to FIGS. 2 and 3, the first flow path 170a has a structure extended from the first supplier 150a and branched into each first spacer 120a; and the second flow path 170s has a structure extended from the second supplier 160a and branched into each second spacer 120s. The flow path disposing structure is referred to a parallel structure.

The water to be treated is branched into each first spacer 120a through the inlet 141a of the gasket 140a and flowed along with the transverse direction of the first spacers 120a; and the draw solution is branched into each second spacer 120s through the inlet 141s of the gasket 140s and flowed along with the transverse direction of the second spacers 120s. The water to be treated is transported along with the mesh 130a, and during the process, the water in the water to be treated is passed through the forward osmosis separation membrane 110 and transported toward the second spacers 120s where the draw solution is flowing, so as to form a flow W.

According to the parallel structure, the water to be treated may have a concentration substantially equivalent at each inlet 141a; and the draw solution may also have a concentration substantially equivalent at each inlet 141s.

Referring to FIG. 2, the direction of transporting the water to be treated along with the transverse direction of the first spacers 120a is same as the direction of transporting the draw solution along with the transverse direction of the second spacers 120s. The flow path disposition like this is called as a co-current cross flow structure.

Referring to FIG. 3, the direction of transporting the water to be treated along with the transverse direction of the first spacers 120a is different from the direction of transporting the draw solution along with the transverse direction of the second spacers 120s. The flow path disposition like this is called as a counter-current cross flow structure.

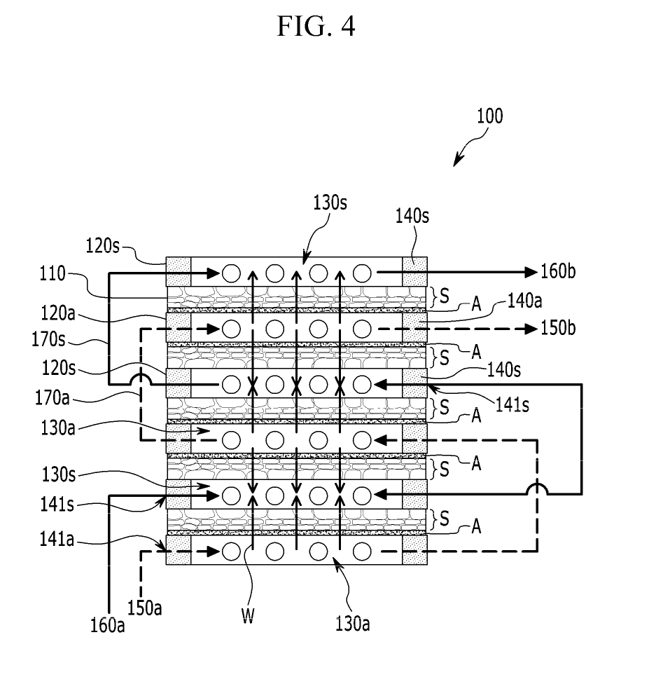

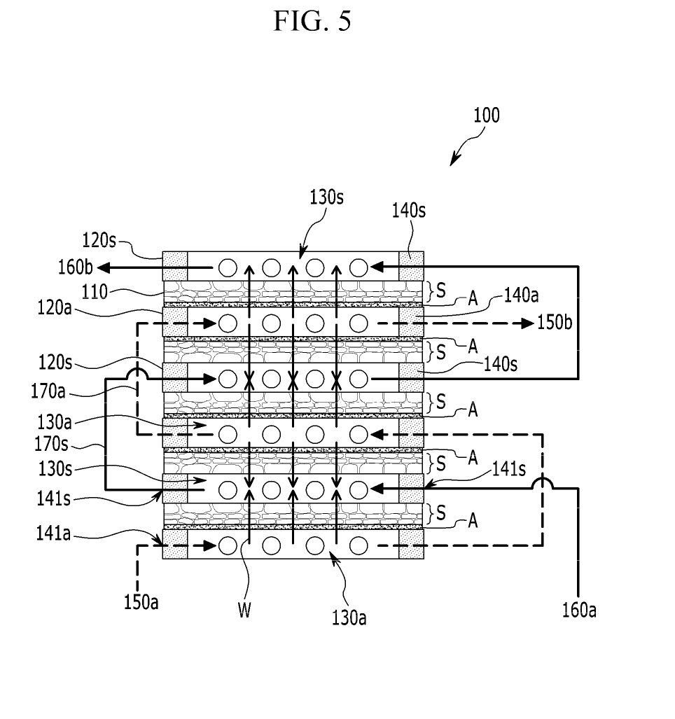

Subsequently, a forward osmosis water treatment device according to further another embodiment is described with reference to FIGS. 4 and 5.

Referring to FIGS. 4 and 5, a first flow path 170a has a structure of extended from the first supplier 150a and sequentially passing the first spacers 120a; and the second flow path 170s has a structure of extended from the second supplier 160a sequentially passing the second spacers 120s. The structure of disposing a flow path is referred to a series structure.

The water to be treated is flowed into any one of first spacers 120a through the inlet 141a of the gasket 140a and then flowed along with the transverse direction of the first spacers 120a; and the draw solution is flowed into any one of the second spacers 120s through the inlet 141s of the gasket 140s and then flowed along with the transverse direction of the second spacers 120s. In this case, the water to be treated is transported along with mesh 130 a, and water of the water to be treated is passed through the forward osmosis separation membrane 110 during the process and transported to the second spacers 120s where the draw solution is flowing, forming a flow W.

According to the series structure, as the water to be treated sequentially passes each the first spacers 120a, the water to be treated may have the different concentration at each the inlet 141a, and the draw solution may have the different concentration at each the inlet 141s, alike this.

Referring to FIG. 4, the forward osmosis water treatment device 100 has a co-current cross flow structure in which the direction of transporting the water to be treated along with the transverse direction of first spacers 120a is same as the direction of transporting the draw solution along with the transverse direction of second spacers 120s.

Referring to FIG. 5, the forward osmosis water treatment device 100 has a count-current cross flow structure in which the direction of transporting the water to be treated along with the transverse direction of first spacers 120a is different from the direction of transporting the draw solution along with the transverse direction of second spacers 120s.

As shown in FIGS. 2 to 5, the water to be treated discharged from the first outlet 150b may have a substantially higher concentration than that of the water to be treated fed from the first supplier 150a.

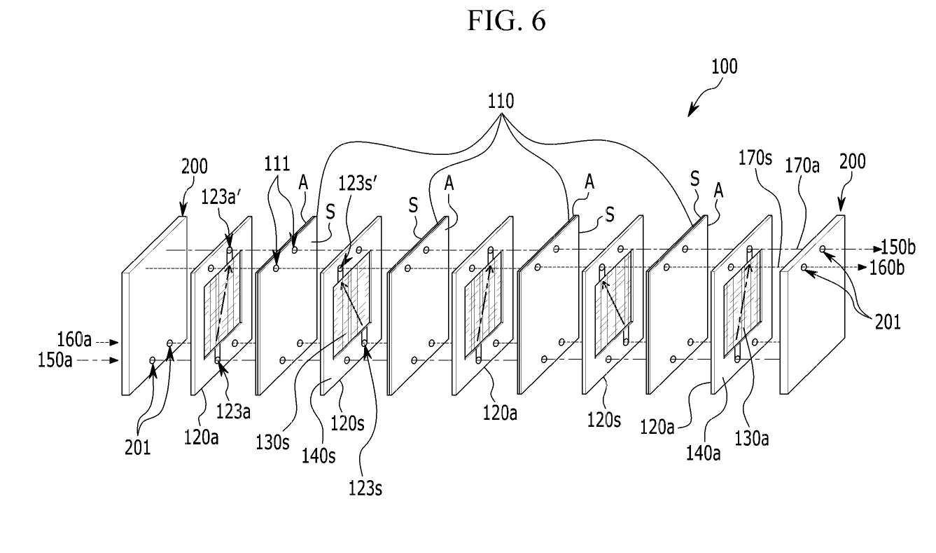

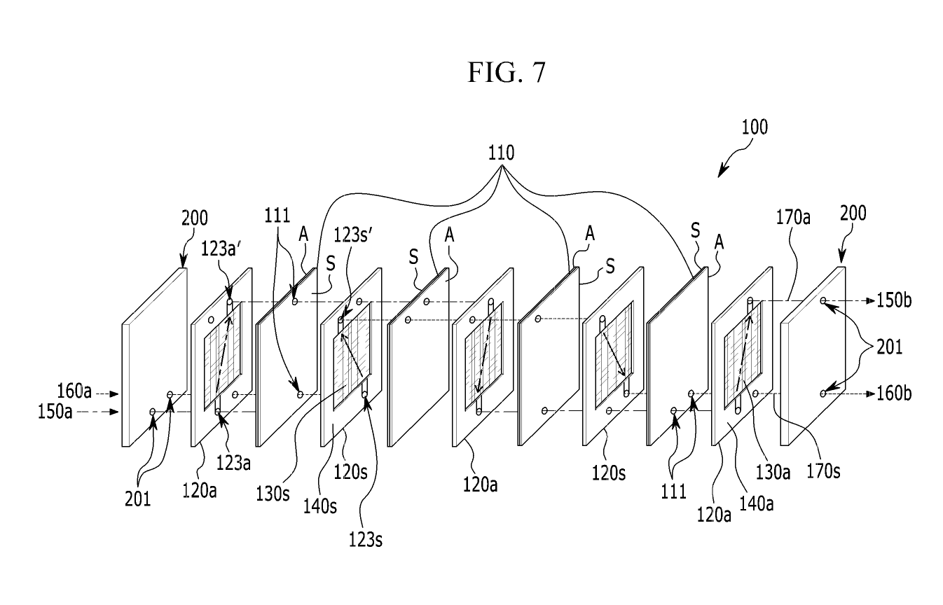

Hereinafter, a forward osmosis water treatment device according to another embodiment is described referring to FIGS. 6 and 7.

FIGS. 6 and 7 are schematic views exemplarily showing flow paths employed for a forward osmosis water treatment device according to an embodiment.

Referring to FIGS. 6 and 7, the first flow path 170a and the second flow path 170s may be formed by each penetrating at least one of a plurality of forward osmosis separation membranes 110. In addition, the first flow path 170a and the second flow path 170s may be formed by each penetrating at least one of a plurality of first and second spacers 120a and 120s.

Referring to FIG. 6, the water to be treated fed from the first supplier 150a is flowed into each first spacer 120a, and the draw solution fed from the second supplier 160a may flowed into each second spacer 120s. In this case, the water to be treated may be flowed in through the inlet 123a and transported along with each mesh 130a toward the opposite side inlet 123a′, which is in a transverse direction along with the arrow; and the draw solution may be flowed in through the inlet 123s and transported along with each mesh 130s toward the opposite inlet 123s′, which is in a transverse direction along with the arrow.

FIG. 7 shows a series structure in which the water to be treated fed from the first supplier 150a and sequentially passed through the first spacers 120a, and the draw solution fed from the second supplier 160a and sequentially passed through the second spacers 120s. Like the parallel structure shown in FIG. 6, the water to be treated may be flowed in through the inlet 123a and transported along with each mesh 130a toward the opposite inlet 123a′, which is in a transverse direction along with the arrow; and the draw solution may be flowed in through the inlet 123s and transported along with each mesh 130s toward the opposite inlet 123s′, which is in a transverse direction along with the arrow.

In FIGS. 6 and 7, each inlet 123a, 123s, 123a′, and 123s′ are all formed penetrating the first and second spacers 120a and 120s, and each through-hole 111 is all formed penetrating the forward osmosis separation membrane 110, but the number or the disposing structure of each inlet and through-hole is not limited thereto.

According to an embodiment, forward osmosis water treatment device 100 may further include two end plates 200 disposed facing each other at the outermost of space defining to include a plurality of forward osmosis separation membranes 110 and a plurality of spacers 120a and 120s. The end plate 200 may a have through-hole 201 flowing in or discharging each the water to be treated and the draw solution.

The forward osmosis separation membrane may be a plate-and-frame type.

The forward osmosis separation membrane according to an embodiment may design the first spacers and the second spacers independently from each other. Thereby, it may reduce the concentration polarization phenomenon decreasing the efficiency of water treatment device or the pressure decreasing phenomenon of permeated water.

The forward osmosis water treatment device may be used for recovering fresh water from brine, refining water to be treated, and purifying polluted water. Water to be treated of the forward osmosis water treatment device may be, for example, sea water, brackish water, or effluent water of sewage treatment.

Hereinafter, the present disclosure is illustrated in more detail with reference to examples. However, these examples are exemplary, and the present disclosure is not limited thereto.

### Manufacture of Forward Osmosis Water Treatment Device

### Example 1

### Plate-and-Frame Type Stack Having Parallel Structure

Polyamide (PA) was coated on a polysulfone (PS) porous support to prepare a PS/PA thin-film composite membrane (TFC). The content of polysulfone included in the polysulfone porous support was 13 wt % based on 100 wt % of solvent (DMF). The composition for coating polyamide was prepared by interface polymerizing 3.4 wt % of m-phenylene diamine (MPD) and 0.15 wt % of trimesoyl chloride (TMC). A membrane area of one thin-film composite membrane was 100 cm².

Meanwhile, a mesh spacer was prepared to provide a channel having a dimension of 100 mm×100 mm×0.7 mm.

Using 3 sheets of the prepared thin-film composite membranes (total membrane area: 300 cm²) and 4 sheets of spacers, a forward osmosis water treatment device having a parallel flow path structure was fabricated. The water to be treated and the draw solution at a temperature of 20° C. were fed into a module in a co-current cross flow, and it was pumped using a gear pump at 1050 mL/min (cross flow velocity=25 cm/s). The water bathes for the water to be treated and the draw solution each have a volume of 15 L.

### Example 2

### Plate-and-Frame Type Stack Having Parallel Structure

A forward osmosis water treatment device was fabricated in accordance with the same procedure as in Example 1, except that 5 sheets of thin-film composite membrane were used to provide the total membrane area of 500 cm², the water bath volumes of water to be treated and draw solution were each 25 L, and 6 sheets of spacers were used.

### Example 3

### Plate-and-Frame Type Stack Having Parallel Structure

A forward osmosis water treatment device was fabricated in accordance with the same procedure as in Example 1, except that 7 sheets of thin-film composite membranes were used to provide the total membrane area of 700 cm², the water bath volumes of water to be treated and draw solution were each 35 L, and 8 sheets of spacers were used.

### Example 4

### Plate-and-Frame Type Stack Having Series Structure

A forward osmosis water treatment device was fabricated in accordance with the same procedure as in Example 1, except the flow path was in series structure.

### Example 5

### Plate-and-Frame Type Stack Having Series Structure

A forward osmosis water treatment device was fabricated in accordance with the same procedure as in Example 2, except the flow path was in series structure.

### Example 6

### Plate-and-Frame Type Stack Having Series Structure

A forward osmosis water treatment device was fabricated in accordance with the same procedure as in Example 3, except the flow path was in series structure.

### Comparative Example 1

### Single Cell

A thin-film composite membrane was prepared in accordance with the same procedure as in Example 1, except the membrane area was 20.02 cm². Subsequently, a spacer having a channel dimension of 77 mm×26 mm×3 mm and including no mesh was prepared.

Using the prepared thin-film composite membrane (membrane area: 20.02 cm²) and the spacer, a forward osmosis water treatment device was fabricated. The water to be treated and the draw solution at a temperature of 20° C. were fed into a module in a co-current cross flow mode, and it was pumped using a gear pump at 1170 mL/min (cross flow velocity=25 cm/s). The water bathes for the water to be treated and the draw solution each had a volume of 2 L.

### Evaluation 1: Water Permeability

In Examples 1 to 6 and Comparative Example 1, the polysulfone layer of composite membrane was disposed facing the draw solution, and the polyamide layer was disposed facing the water to be treated (FO mode). The draw solution (DS) included a sodium chloride (NaCl) aqueous solution having a concentration of each 0.5 M, 1.0 M and 2.0 M, and the water to be treated included deionized water.

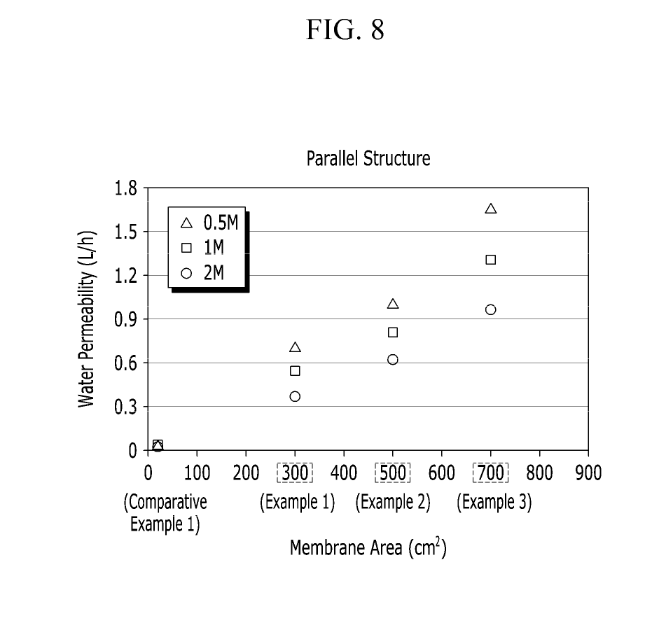

The amount of water transporting from the water to be treated to the draw solution interposing the composite membrane was measured to evaluate a water permeability. The water amount transported toward the draw solution was measured by observing how the scale where the water bath accommodating the draw solution is put on was changed depending upon a time (30 minutes) (L/m²·hr), and the data was collected every 1 minute. The results are described with reference to FIGS. 8 to 13.

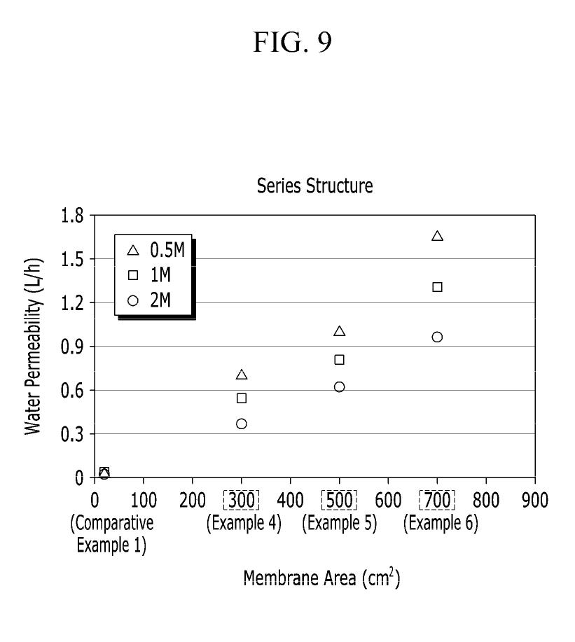

FIG. 8 is a graph showing a water permeability of the forward osmosis water treatment devices according to Examples 1 to 3 comparing to the forward osmosis water treatment device according to Comparative Example 1 and FIG. 9 is a graph showing a water permeability of the forward osmosis water treatment devices according to Examples 4 to 6 comparing to the forward osmosis water treatment device according to Comparative Example 1.

Referring to FIGS. 8 and 9, it is understood that the water permeability in the forward osmosis water treatment devices according to Examples 1 to 6 was linearly increased according to increasing the total membrane area.

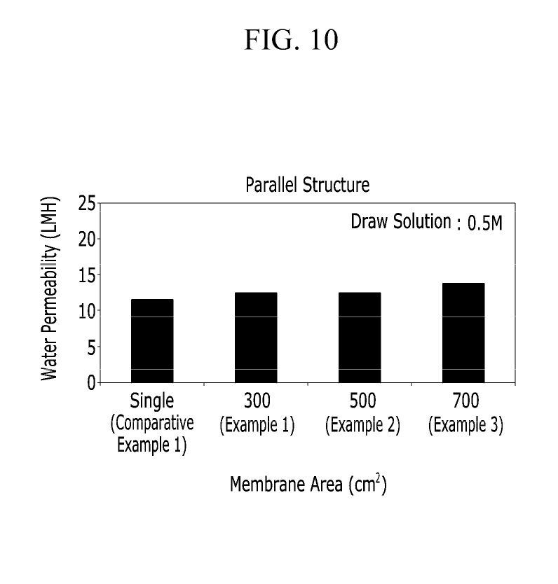

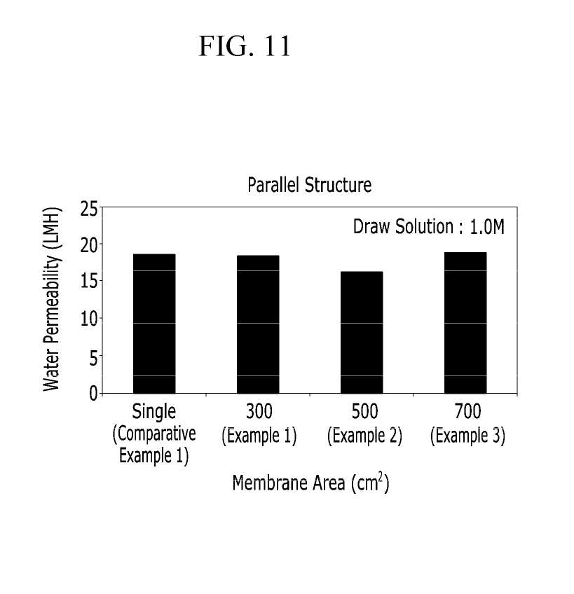

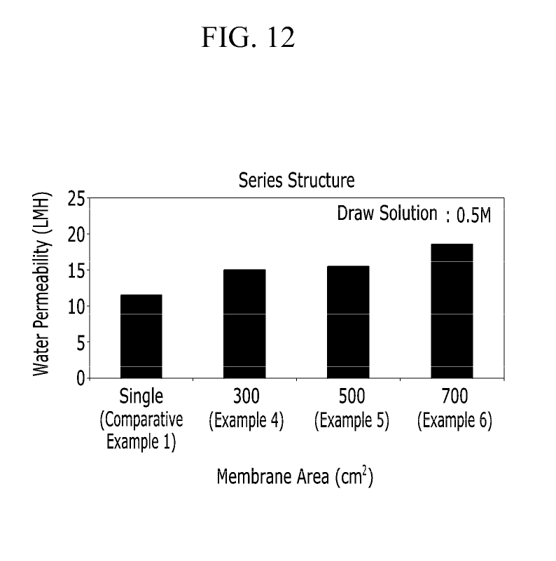

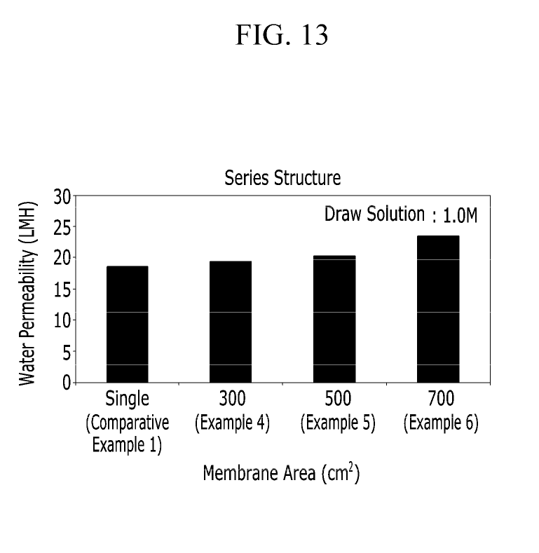

FIGS. 10 and 11 are graphs showing a water permeability of the forward osmosis water treatment devices according to Examples 1 to 3 considering the membrane area, comparing to the forward osmosis water treatment device of Comparative Example 1 and FIGS. 12 and 13 are graphs showing a water permeability of the forward osmosis water treatment devices according to Examples 4 to 6 considering the membrane area, comparing to the forward osmosis water treatment device of Comparative Example 1.

Referring to FIGS. 10 to 13, the water permeability calculated considering the area of forward osmosis water treatment devices according to Examples 1 to 6 also showed the equivalent results or the more improved results comparing to the single cell module (11.5 LMH@0.5M NaCl, 18.6 LMH@1.0) according to Comparative Example 1, as in above. This tendency may be found in both Examples 1 to 3 having the parallel flow path structure and Examples 4 to 6 having the series flow path structure.

### Evaluation 2: Back Diffusion of Salts

In the forward osmosis water treatment devices according to Examples 3 and 6, Comparative Example 1, the polysulfone layer having a composite membrane was disposed facing the draw solution, and the polyamide layer was disposed facing the water to be treated (FO mode). The draw solution included a sodium chloride (NaCl) aqueous solution having a concentration of each 0.5 M, 1.0 M and 2.0 M, and the water to be treated included deionized water.

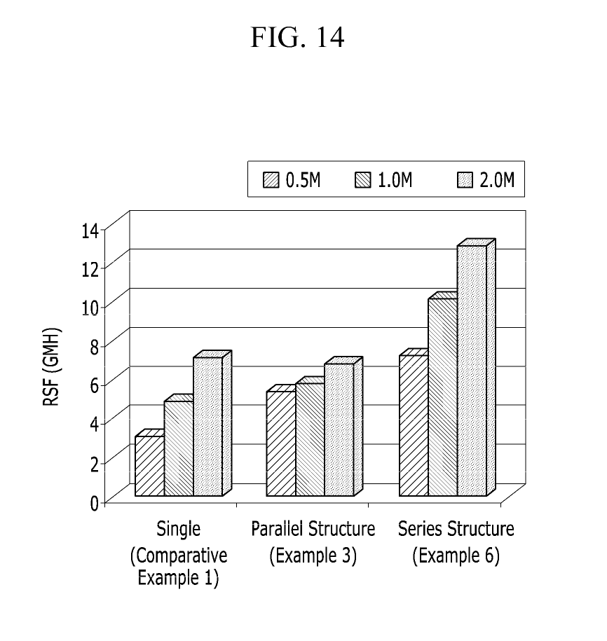

The salt amount transported from the draw solution to the water to be treated through the forward osmosis separation membrane was measured to evaluate the back diffusion characteristics of salts. The salt transporting amount (g/m²·hr) was calculated by measuring the electric conductivity every 1 minute. The evaluation results are described with reference to FIG. 14.

FIG. 14 is a graph showing back diffusion characteristics of salts of forward osmosis water treatment devices according to Examples 3 and 6, and Comparative Example 1.

Referring to FIG. 14, it is confirmed that the forward osmosis water treatment devices according to Examples 3 and 6 generated a higher back diffusion of salts than in the single cell module according to Comparative Example 1 but was not higher than the generally known forward osmosis (FO) performance of RSF 10 GMH. The reason why the phenomenon was more remarkable in Example 6 having a series flow path structure is estimated because the length of contacting the salt in solution with the separation membrane was increased, so as to increase the salt transporting into the active layer of separation membrane.

### Evaluation 3: Pressure Change in Flow Path of Water to be Treated and Draw Solution

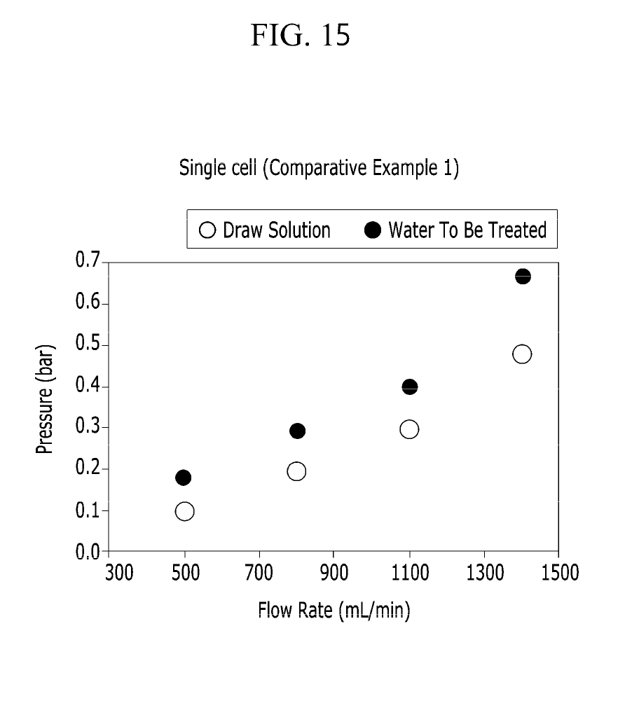

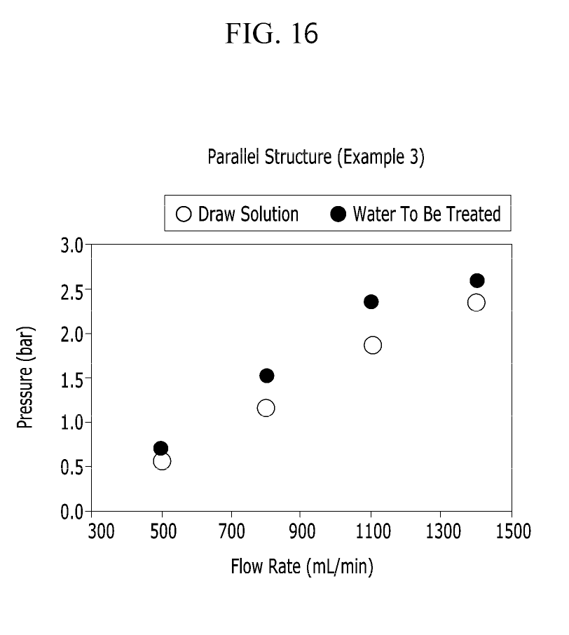

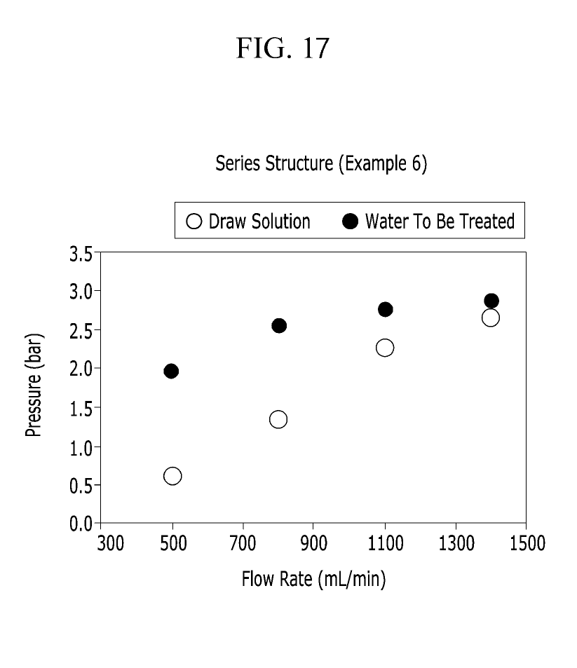

In the forward osmosis water treatment devices according to Examples 3 and 6, Comparative Example 1, the pressure at the inlet of the water to be treated and the inlet of the draw solution was measured at a flow rate of each 500, 800, 1100 and 1400 mL/min. The other experimental conditions were same as in Evaluation 2. The results are described with reference to FIGS. 15 to 17.

FIGS. 15 to 17 are graphs showing a pressure generated in flow paths of the forward osmosis water treatment devices according to Comparative Example 1, Example 3, and Example 6, respectively.

Referring to FIGS. 15 to 17, it is understood that in all the forward osmosis water treatment devices according to Examples 3 and 6, Comparative Example 1, the pressure difference generated between the water to be treated inlet and the draw solution inlet was relatively lower than the generally known pressure difference of spiral-wound module. This is estimated that in the plate-and-frame type stack structure, the water to be treated flow path and the draw solution flow path are structured in symmetrical to each other, so the pressure difference generated between two flow paths is decreased unlike the spiral-wound module.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. A forward osmosis water treatment device, comprising:
a stack structure including,
a plurality of forward osmosis separation membranes, each of the plurality of forward osmosis separation membranes including an active layer and a support layer;
first spacers between two active layers of the plurality of forward osmosis separation membranes facing each other, the first spacers forming a first flow path of water to be treated; and
second spacers between two support layers of the plurality of forward osmosis separation membranes facing each other, the second spacers forming a second flow path of a draw solution.

2. The forward osmosis water treatment device of claim 1, wherein each of the plurality of forward osmosis separation membranes selectively permeates water such that the water to be treated passing the first spacers is transported into the draw solution passing the second spacers.

3. The forward osmosis water treatment device of claim 1, wherein each of the first flow path and the second flow path penetrate at least one of the plurality of forward osmosis separation membranes.

4. The forward osmosis water treatment device of claim 1, wherein
the first spacers include a region where the water to be treated is transported along a transverse direction of the first spacers; and
the second spacers include a region where the draw solution is transported along the transverse direction of the second spacers.

5. The forward osmosis water treatment device of claim 4, wherein each of the regions of the first spacers and the second spacers is a mesh region.

6. The forward osmosis water treatment device of claim 5, wherein the first spacers and the second spacers each include a gasket defining the respective mesh region.

7. The forward osmosis water treatment device of claim 6, wherein each of the gaskets has inlets passing the water to be treated and the draw solution.

8. The forward osmosis water treatment device of claim 7, wherein the inlets are at a terminal end of the gasket or penetrate the gasket.

9. The forward osmosis water treatment device of claim 4, wherein the transverse direction that the water to be treated is transported along the first spacers is the same as the transverse direction that the draw solution is transported along the second spacers.

10. The forward osmosis water treatment device of claim 4, wherein the transverse direction that the water to be treated is transported along the first spacers is different from the transverse direction that the draw solution is transported along the second spacers.

11. The forward osmosis water treatment device of claim 1, further comprising:
a first supplier configured to feed the water to be treated;
a second supplier configured to feed the draw solution;
a first outlet discharging the water to be treated from the first supplier so as to pass through a plurality of first spacers; and
a second outlet discharging the draw solution from the second supplier so as to pass through a plurality of second spacers,
wherein the first supplier and the first outlet form the first flow path along with the first spacers, and
wherein the second supplier and the second outlet form the second flow path along with the second spacers.

12. The forward osmosis water treatment device of claim 11, wherein the water to be treated passing the first flow path is fluidically separated from the draw solution passing the second flow path.

13. The forward osmosis water treatment device of claim 11, wherein
the first flow path extends from the first supplier and branches into each of the first spacers; and
the second flow path extends from the second supplier and branches into each of the second spacers.

14. The forward osmosis water treatment device of claim 11, wherein
the first flow path extends from the first supplier and sequentially passes the first spacers; and
the second flow path extends from the second supplier and sequentially passes the second spacers.

15. The forward osmosis water treatment device of claim 11, wherein the water to be treated discharged from the first outlet has a higher concentration than the water to be treated from the first supplier.

16. The forward osmosis water treatment device of claim 1, wherein each of the plurality of forward osmosis separation membranes has a plate-and-frame type stack structure.
